(19) United States
(12) Patent Application Publication
(10) Pub. No.: US 2008/0170541 A1
(43) Pub. Date: Jul. 17, 2008

(54) Apparatus, methods, and computer program products providing resource allocation adaptation for point-to-multipoint transmissions

(75) Inventors: Ville Vartiainen, Oulu (FI); Janne Kurjenniemi, Jyvaskyla (FI); Jorma Kaikkonen, Oulu (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 12/008,495

(22) Filed: Jan. 11, 2008

Related U.S. Application Data
(60) Provisional application No. 60/880,291, filed on Jan. 12, 2007.

(51) Int. Cl. H04Q 7/24

(52) U.S. Cl. 370/328

(57) ABSTRACT

In one exemplary embodiment, a method includes: obtaining feedback from at least one mobile terminal in a communication system; determining, based on the obtained feedback, whether at least one of a downlink shared channel transmit power and a transmission pattern should be modified, wherein the downlink shared channel is used to communicate with a plurality of users; and in response to determining that at least one of the downlink shared channel transmit power and the transmission pattern should be modified, modifying at least one of the downlink shared channel transmit power and the transmission pattern. In a further exemplary embodiment, the method further includes: transmitting a communication to the plurality of users via the downlink shared channel, wherein the communication is a multimedia broadcast/multicast service transmission and the downlink shared channel is a high speed downlink shared channel or a physical downlink shared channel.

### CROSS-REFERENCE TO RELATED APPLICATIONS:

This patent application claims priority under 35 U.S.C. § 119(e) from Provisional Patent Application No. 60/880,291, filed Jan. 12, 2007, the disclosure of which is incorporated by reference herein in its entirety.

### TECHNICAL FIELD

The exemplary embodiments of this invention relate generally to wireless communication systems and, more specifically, relate to resource allocation for point-to-multipoint transmissions in packet communication systems.

### BACKGROUND

The following abbreviations are utilized herein:
3GPP third generation partnership project
ACK acknowledgement
CDF cumulative distribution function
CQI channel quality information
DCH dedicated transport channel
DCCH dedicated control logical channel
DPDCH dedicated physical data channel
DTCH dedicated traffic logical channel
FACH forward access transport channel
HARQ hybrid automatic repeat-request
HSDPA high speed downlink packet access
HS-DPCCH high speed dedicated physical control channel
HS-DSCH high speed downlink shared channel
MAC medium access control (layer 2, L2)
MBMS multimedia broadcast/multicast service
MCCH MBMS p-t-m control logical channel
MCS modulation and coding scheme
MTCH MBMS p-t-m traffic logical channel
NACK negative acknowledgement
Node B base station
p-t-m point-to-multipoint
p-t-p point-to-point
PDSCH physical downlink shared channel
PHY physical layer (layer 1, L1)
QoS quality of service
S-CCPCH secondary common control physical channel
SINR signal to interference-plus-noise ratio
TTI transmission time interval
UE user equipment, such as a mobile station or mobile terminal
WG working group

In 3GPP Release 6, MBMS was specified at the PHY level to (i) use the FACH mapped to the S-CCPCH for p-t-m transmission, or (ii) use the DCH mapped to the DPDCH for p-t-p transmission, depending on the number of users. At the MAC level, the MBMS was specified to use the DCCH and DTCH in the p-t-p transmission scenario, and the MCCH and MTCH in the p-t-m transmission scenario. In the development of 3GPP Release 7, there has been an MBMS enhancement study item in WG2, which was recently closed.

3GPP Release 5 specifications define HSDPA that delivers data to users over a HS-DSCH. Each user also maintains a dedicated connection and delivers uplink acknowledgements for the HARQ retransmission protocol and CQI for helping the scheduler using a HS-DPCCH. Thus, the downlink channel, utilising the HARQ mechanism, requires a dedicated uplink feedback link for acknowledging the received packets and possibly delivering other information about the receiver's situation (e.g., CQI).

One specification of particular relevance to this application is 3GPP TS 25.214 V7.3.0, “3rd Generation Partnership Project; Technical Specification Group Radio Access Network; Physical layer procedures (FDD) (Release 7),” December 2006.

### SUMMARY

In an exemplary embodiment of the invention, a method includes: obtaining feedback from at least one mobile terminal in a communication system; determining, based on the obtained feedback, whether at least one of a downlink shared channel transmit power and a transmission pattern should be modified, wherein the downlink shared channel is used to communicate with a plurality of users; and in response to determining that at least one of the downlink shared channel transmit power and the transmission pattern should be modified, modifying at least one of the downlink shared channel transmit power and the transmission pattern.

In another exemplary embodiment, a program storage device readable by a machine, tangibly embodying a program of instructions executable by the machine for performing operations, said operations comprising: obtaining feedback from at least one mobile terminal in a communication system; determining, based on the obtained feedback, whether at least one of a downlink shared channel transmit power and a transmission pattern should be modified, wherein the downlink shared channel is used to communicate with a plurality of users; and in response to determining that at least one of the downlink shared channel transmit power and the transmission pattern should be modified, modifying at least one of the downlink shared channel transmit power and the transmission pattern.

In another exemplary embodiment, an apparatus comprising: a receiver configured to obtain feedback from at least one mobile terminal in a communication system; and a processor configured to determine, based on the obtained feedback, whether at least one of a downlink shared channel transmit power and a transmission pattern should be modified, wherein the downlink shared channel is used to communicate with a plurality of users, wherein the processor is further configured to modify at least one of the downlink shared channel transmit power and the transmission pattern in response to determining that at least one of the downlink shared channel transmit power and the transmission power should be modified.

In another exemplary embodiment, an apparatus comprising: means for obtaining feedback from at least one mobile terminal in a communication system; means for determining, based on the obtained feedback, whether at least one of a downlink shared channel transmit power and a transmission pattern should be modified, wherein the downlink shared channel is used to communicate with a plurality of users; and means for modifying at least one of the downlink shared channel transmit power and the transmission pattern in response to determining that at least one of the downlink shared channel transmit power and the transmission pattern should be modified.

### BRIEF DESCRIPTION OF THE DRAWINGS

The foregoing and other aspects of exemplary embodiments of this invention are made more evident in the following Detailed Description, when read in conjunction with the attached Drawing Figures, wherein:

FIG. 1 shows a simplified block diagram of various electronic devices that are suitable for use in practicing the exemplary embodiments of this invention;

FIG. 2 presents CDF of used transmit power with different numbers of admitted users for an exemplary wireless system incorporating aspects of the exemplary embodiments of the invention;

FIG. 3 presents CDF of HS-DSCH SINR with different numbers of admitted users for an exemplary wireless system incorporating aspects of the exemplary embodiments of the invention;

FIG. 4 depicts a flowchart illustrating one non-limiting example of a method for practicing the exemplary embodiments of this invention; and

FIG. 5 depicts a flowchart illustrating another non-limiting example of a method for practicing the exemplary embodiments of this invention.

### DETAILED DESCRIPTION

In a p-t-p HSDPA scheme, fixed transmit power is used for the HS-DSCH but link adaptation is performed based on UE-reported CQI, where modulation, coding and the number of used multicodes are modified to be able to provide higher bitrates in better channel conditions. In a p-t-m HSDPA scheme, high peak data rates are generally not needed as service is mainly intended for constant bit rate streaming (e.g., mobile television signal). To provide high spectral efficiency and optimize usage of available resources in a p-t-m HSDPA scheme, link adaptation based on UE-reported feedback would be desirable. Efficient link adaptation in the p-t-m HSDPA scheme could be achieved by controlling either the used HS-DSCH transmission power resource or time resource.

In principle, the exemplary embodiments of the invention could be viewed as outer loop power control for HSDPA. Outer loop power control has previously been used in the context of DCH, but it has not been used for p-t-p HSDPA or p-t-m HSDPA.

Outer loop power control for CDMA systems has been previously presented in A. Sampath, P. Sarath Kumar and J. M. Holtzman, “On setting reverse link target SIR in a CDMA system”, IEEE Vehicular Technology Conference, Phoenix, Ariz., USA, May 4-7, 1997, pp. 929-933.

An ACK/NACK-based outer loop for link adaptation has been previously discussed, for example, in M. Nakamura, Y. Awad, S. Vadgama, “Adaptive Control of Link Adaptation for High Speed Downlink Packet Access (HSDPA) in W-CDMA”, in Proc. WMPC, 2002, pp. 382-386.

Furthermore, in TSG RAN WG1 meeting 47, InterDigital presented a contribution discussing time domain-based resource adaptation. R1-063488, “Performance of MBMS on HSDPA channel with feedback,” InterDigital, Riga, Latvia, Nov. 6-10, 2006.

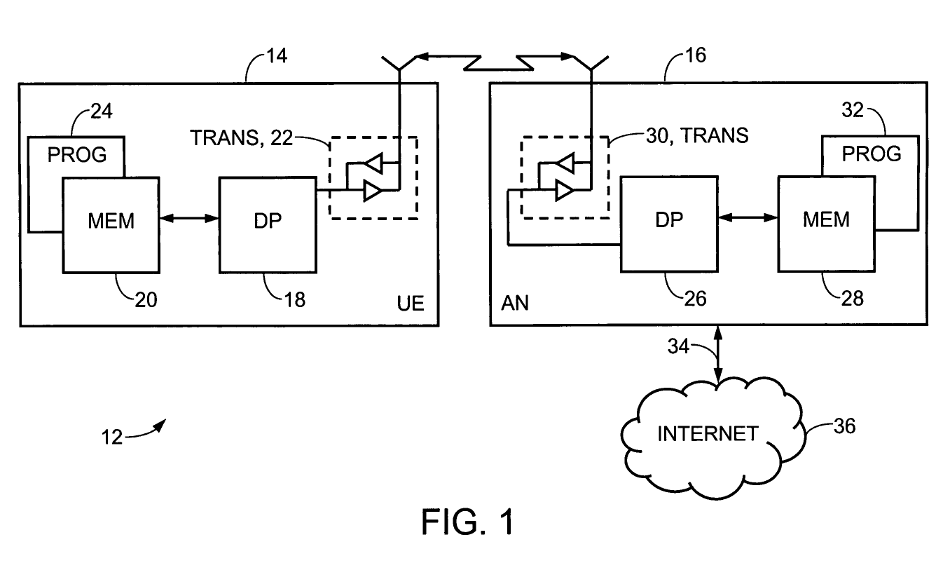

Reference is made to FIG. 1 for illustrating a simplified block diagram of various electronic devices that are suitable for use in practicing the exemplary embodiments of this invention. In FIG. 1, a wireless network 12 is adapted for communication with a user equipment (UE) 14 via an access node (AN) 16. The UE 14 includes a data processor (DP) 18, a memory (MEM) 20 coupled to the DP 18, and a suitable RF transceiver (TRANS) 22 (having a transmitter (TX) and a receiver (RX)) coupled to the DP 18. The MEM 20 stores a program (PROG) 24. The TRANS 22 is for bidirectional wireless communications with the AN 16. Note that the TRANS 22 has at least one antenna to facilitate communication.

The AN 16 includes a data processor (DP) 26, a memory (MEM) 28 coupled to the DP 26, and a suitable RF transceiver (TRANS) 30 (having a transmitter (TX) and a receiver (RX)) coupled to the DP 26. The MEM 28 stores a program (PROG) 32. The TRANS 30 is for bidirectional wireless communications with the UE 14. Note that the TRANS 30 has at least one antenna to facilitate communication. The AN 16 is coupled via a data path 34 to one or more external networks or systems, such as the internet 36, for example.

At least one of the PROGs 24, 32 is assumed to include program instructions that, when executed by the associated DP, enable the electronic device to operate in accordance with the exemplary embodiments of this invention, as discussed herein.

In general, the various embodiments of the UE 14 can include, but are not limited to, mobile terminals, mobile phones, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by one or more of the DPs 18, 26 of the UE 14 and the AN 16, or by hardware, or by a combination of software and hardware.

The MEMs 20, 28 may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DPs 18, 26 may be of any type suitable to the local technical environment, and may include one or more of general purpose computers, special purpose computers, microprocessors, digital signal processors (DSPs) and processors based on a multi-core processor architecture, as non-limiting examples.

While FIG. 1 illustrates elements of a p-t-p connection (i.e., between the AN 16 and the UE 14), other exemplary embodiments of the invention may be suitable for use in conjunction with a p-t-m connection, for example, between the AN 16 and a plurality of UEs. One of ordinary skill in the art will appreciate this extension and the various components that may be utilized. As a non-limiting example, the UE 14 in FIG. 1 may comprise a first UE (UE1) and the AN 16 may be configured to additionally communicate with at least a second UE (UE2). The UE2 may comprise at least one data processor, at least one memory storing a program, at least one transceiver and at least one antenna, similar to UE1 14, as non-limiting examples. Furthermore, the AN 16 may comprise a plurality of antennas and/or a plurality of transceivers that enable the AN 16 to communicate with UEs using both MBMS and unicast communications, as non-limiting examples.

One non-limiting, exemplary method for enhancing the p-t-m spectral efficiency comprises reducing average transmission power for p-t-m HSDPA by either controlling transmission power based on UE-reported feedback or by adjusting the used (re)transmission pattern based on UE-reported feedback.

Since changing the modulation, coding and number of used multicodes in a p-t-p HSDPA transmission may provide gains in bit rate, controlling HS-DSCH transmit power based on UE-reported feedback may be better suited for a p-t-m HSDPA transmission. In such a manner, the usage of transmit power can be further optimized and the average HS-DSCH transmit power can be reduced.

Transmit power control can be based on UE-reported NACKs, as a non-limiting example. UEs generally report a NACK to the Node B when they fail to receive a HS-DSCH transmission correctly. In the Node B, the number of received NACKs may be compared to the number of p-t-m HSDPA users and, if that proportion exceeds a predefined limit, the transmit power can be increased. Otherwise, the transmit power can be reduced. Power control step sizes can be defined similarly as in outer loop power control (i.e., the step size for the up command is greater than the step size for the down command).

The transmit power control can alternatively be based on UE CQI reports by adjusting the used power based on the statistic of received CQI reports. Thus, the Node B is aware of the reference HS-DSCH power (e.g., via signaled measurement power offset F, see Section 6A.2 of TS 25.214) used in deriving the CQI report. The Node B is also aware of the actual HS-DSCH power and MCS used for the p-t-m transmission. By resealing the received CQI reports or the actual, used p-t-m MCS by the difference between the assumed HS-DSCH power (e.g., provided by the UE in deriving the CQI report) and the actual, used HS-DSCH power, the Node B can approximate, for example, the amount/portion of CQI reports that are below the used MCS. If this value exceeds some predefined limit, then the used HS-DSCH transmission power could be increased. In contrast, if the amount/portion of (scaled) CQI reports indicating better link performance than assumed by the used power allocation is larger than some predefined threshold, the power could be reduced.

As the capacity of a broadcast system is generally limited by the worst users, by using the exemplary embodiments of the invention, transmit power usage can be optimized for the current situation in the network. With a relatively low number of users, expected power savings are higher than for a higher number of users.

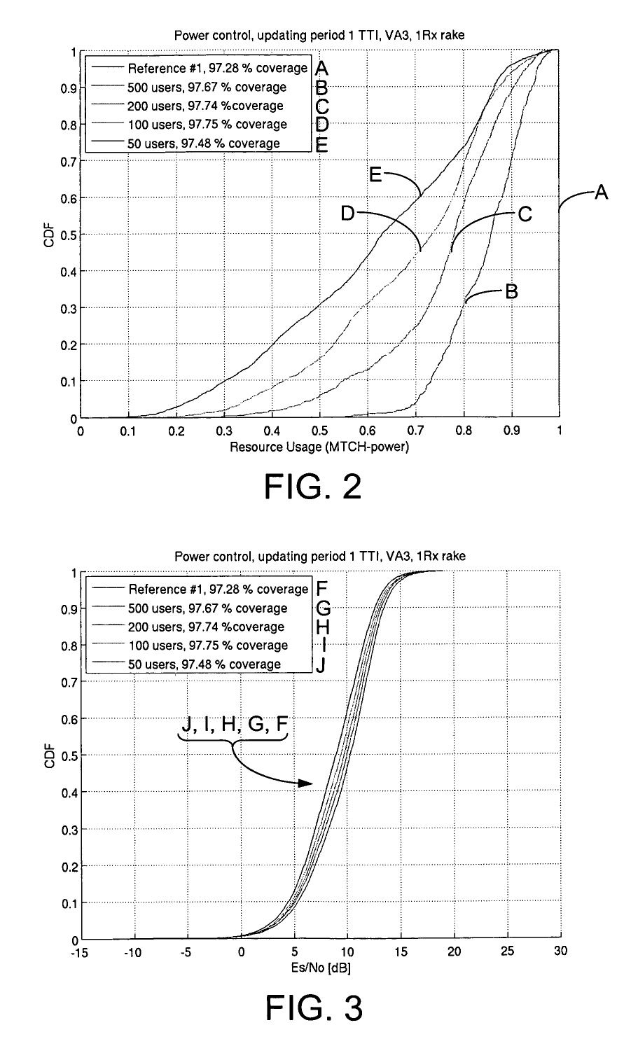

Performance of an exemplary power control method for p-t-m HSDPA has been evaluated in the context of a dynamic WCDMA system level simulator with different numbers of users. The simulation results are presented in Table 1 below. Table 1 shows the number of users in the simulation, the average MTCH power for 95% coverage and the expected power savings as compared to fixed MTCH transmission power. In these simulated cases, gain from the proposed power control method ranges from 15.5% (for 500 users) to 38.4% (for 50 users). Additional simulation results for an exemplary system utilizing aspects of the exemplary embodiments of the invention are also presented in FIGS. 2 and 3. FIG. 2 shows CDF of transmit power and FIG. 3 shows CDF of HS-DSCH SINR. As apparent by the SINR distribution of FIG. 3, the lower tail of the SINR distribution remains almost unchanged. Thus, 95% coverage can be maintained. Median SINRs are lower with power control due to the optimized power allocation.

TABLE 1

| | Average MTCH | |
|---|---|---|
| | power for 95% | |
| Case | coverage | Power Savings |
| Fixed number of users | 14.16 W | — |
| 500 users | 11.97 W | 15.5% |
| 200 users | 10.75 W | 24.1% |
| 100 users | 9.74 W | 31.1% |
| 50 users | 8.73 W | 38.4% |

In a further exemplary aspect of the invention, another way of achieving more efficient link adaptation and improving p-t-m HSDPA spectral efficiency is to adjust the (re)transmission pattern based on UE-reported CQI. For example, in good channel conditions the scheduling frequency can be lowered whereas in bad channel conditions more frequent scheduling is needed. In this scheme, UEs report CQIs to the serving Node B. Based on the lowest reported CQI, the Node B calculates the inter-TTI distance to provide constant bit rate service to the UEs. In this scheme, modulation, coding and the number of multicodes may not be changed as the adaptation is based on scheduling frequency.

As a non-limiting example, consider the following. If Tb_{Minimum} defines the transport block size when all TTIs are used to transmit data (i.e., when the inter-TTI interval is 1), then Tb_{Supported} corresponds to the transport block size that can be used based on received CQIs. As a result, the inter-TTI interval (D_{InterTTI}) can be defined as:

$${D}_{InterTTI} = \frac{{Tb}_{Supported}}{{Tb}_{Mininum}} . \qquad ( 1 )$$

The inter-TTI interval defines the scheduling frequency. Thus, when reported CQIs are high, the scheduling frequency can be lowered and savings in transmission resources can be achieved in the time domain. In addition, the number of HARQ retransmissions can be changed when the inter-TTI interval is greater than 1. TTIs that are not needed or used for p-t-m HSDPA transmission can be used for other services.

As can be seen, the exemplary embodiments of the invention control HS-DSCH transmission power based on UE-reported feedback, thus providing for further optimization of transmission power usage while still maintaining desired QoS targets. By reducing average transmit power of p-t-m HSDPA, a portion of the power (i.e., the saved power) can be allocated to other services (e.g., HSDPA with background traffic). The exemplary power control methods presented provide enhanced adaptation, especially with a variable number of users that have subscribed to the service delivered by the p-t-m HSDPA scheme. Controlling the HS-DSCH transmission power does not require full feedback as, for example, only the reporting of NACKs is needed to provide efficient link adaptation.

Furthermore p-t-m HSDPA spectral efficiency can also be increased by adjusting the (re)transmission pattern based on UE-reported feedback. In such a manner, transmission resource usage can be further optimized in the time domain, thus providing room (e.g., resources) for other services.

Although in some exemplary embodiments the NACKs may have to be reported in the uplink, the amount of NACKs can be set to be lower, for example, by predefining that a UE sends a NACK only if the last or second to last re-transmission has failed. Although in other exemplary embodiments the CQIs may have to be reported in the uplink, some predefined CQI threshold could be used to activate or deactivate the CQI reporting.

Below are provided further descriptions of non-limiting, exemplary embodiments. The below-described exemplary embodiments are separately numbered for clarity and identification. This numbering should not be construed as wholly separating the below descriptions since various aspects of one or more exemplary embodiments may be practiced in conjunction with one or more other aspects or exemplary embodiments.

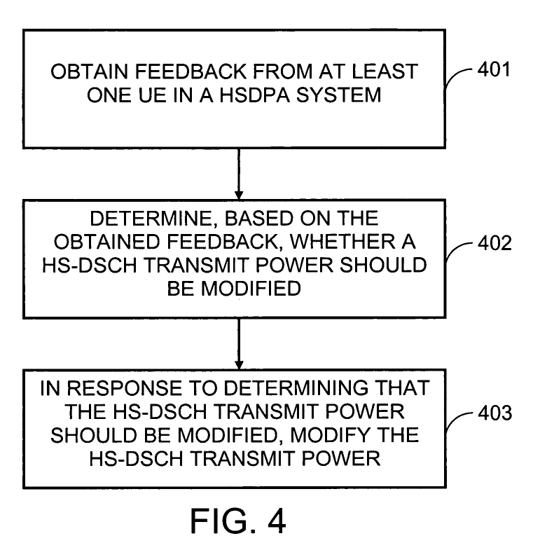

(1) In one non-limiting, exemplary embodiment, and as illustrated in FIG. 4, a method includes: obtaining feedback from at least one UE in a HSDPA system (401); determining, based on the obtained feedback, whether a HS-DSCH transmit power should be modified (402); and, in response to determining that the HS-DSCH transmit power should be modified, modifying the HS-DSCH transmit power (403).

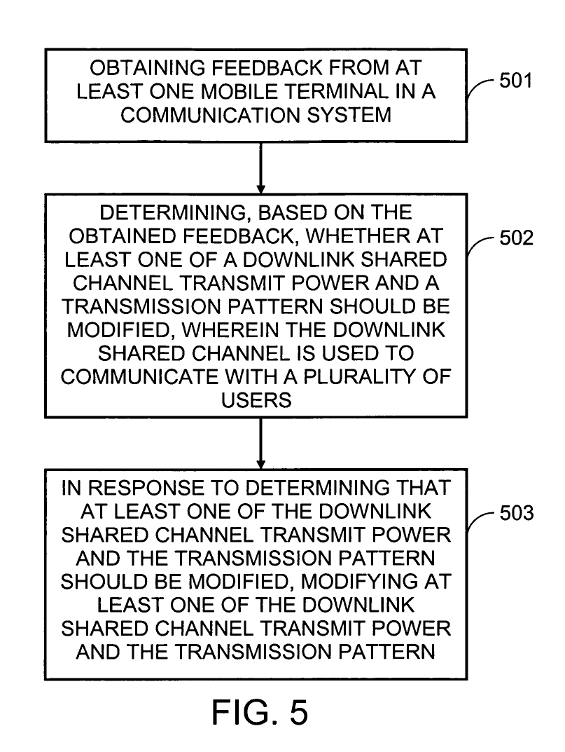

(2) In another exemplary embodiment, and as shown in FIG. 5, a method comprising: obtaining feedback from at least one mobile terminal in a communication system (501); determining, based on the obtained feedback, whether at least one of a downlink shared channel transmit power and a transmission pattern should be modified, wherein the downlink shared channel is used to communicate with a plurality of users (502); and in response to determining that at least one of the downlink shared channel transmit power and the transmission pattern should be modified, modifying at least one of the downlink shared channel transmit power and the transmission pattern (503).

A method as above, wherein the obtained feedback comprises a negative acknowledgement, channel quality information or a channel quality information report. A method as in any above, wherein determining whether the downlink shared channel transmit power should be modified comprises using at least the obtained feedback, a number of mobile terminals in the communication system and a predetermined value. A method as in any above, wherein the obtained feedback comprises a negative acknowledgement, wherein determining whether the downlink shared channel transmit power should be modified comprises comparing a number of obtained negative acknowledgements to a number of mobile terminals in the communication system and increasing or decreasing the downlink shared channel transmit power in response to the comparison exceeding, equaling or falling below a predetermined value. A method as in any above, wherein the obtained feedback comprises a channel quality information (CQI) report, wherein determining whether the downlink shared channel transmit power should be modified comprises approximating an amount of CQI reports that are below a modulation and coding scheme and comparing the approximated amount to a predefined value.

A method as in any above, wherein the obtained feedback comprises channel quality information (CQI), wherein determining whether the transmission pattern should be modified comprises using a lowest CQI to calculate an inter-transmission time interval (TTI) distance to provide constant bit rate service, wherein the transmission pattern is modified based on the calculated inter-TTI distance. A method as in any above, wherein the transmission pattern comprises a retransmission pattern or a hybrid automatic repeat-request retransmission pattern. A method as in any above, further comprising: transmitting a communication to the plurality of users via the downlink shared channel, wherein the communication comprises a multimedia broadcast/multicast service transmission and the downlink shared channel comprises a high speed downlink shared channel or a physical downlink shared channel.

A method as in any above, wherein the communication system comprises a packet communication system or a HSPA system. A method as in any above, further comprising: transmitting a communication to the plurality of users via the downlink shared channel. A method as in any above, further comprising: transmitting a communication to the plurality of users via the downlink shared channel, wherein the communication comprises a multimedia broadcast/multicast service transmission. A method as in any above, wherein the downlink shared channel comprises a high speed downlink shared channel or a physical downlink shared channel. A method as in any above, wherein the method is performed by a base station (e.g., of the communication system). A method as in any above, wherein the communication system comprises a wireless communication system. A method as in any above, wherein the method is implemented by a computer program.

(3) In another exemplary embodiment, a program storage device readable by a machine, tangibly embodying a program of instructions executable by the machine for performing operations, said operations comprising: obtaining feedback from at least one mobile terminal in a communication system (501); determining, based on the obtained feedback, whether at least one of a downlink shared channel transmit power and a transmission pattern should be modified, wherein the downlink shared channel is used to communicate with a plurality of users (502); and in response to determining that at least one of the downlink shared channel transmit power and the transmission pattern should be modified, modifying at least one of the downlink shared channel transmit power and the transmission pattern (503).

A program storage device as above, wherein the obtained feedback comprises a negative acknowledgement, channel quality information or a channel quality information report. A program storage device as in any above, wherein determining whether the downlink shared channel transmit power should be modified comprises using at least the obtained feedback, a number of mobile terminals in the communication system and a predetermined value. A program storage device as in any above, wherein the obtained feedback comprises a negative acknowledgement, wherein determining whether the downlink shared channel transmit power should be modified comprises comparing a number of obtained negative acknowledgements to a number of mobile terminals in the communication system and increasing or decreasing the downlink shared channel transmit power in response to the comparison exceeding, equaling or falling below a predetermined value.

A program storage device as in any above, wherein the obtained feedback comprises a channel quality information (CQI) report, wherein determining whether the downlink shared channel transmit power should be modified comprises approximating an amount of CQI reports that are below a modulation and coding scheme and comparing the approximated amount to a predefined value. A program storage device as in any above, wherein the obtained feedback comprises channel quality information (CQI), wherein determining whether the transmission pattern should be modified comprises using a lowest CQI to calculate an inter-transmission time interval (TTI) distance to provide constant bit rate service, wherein the transmission pattern is modified based on the calculated inter-TTI distance. A program storage device as in any above, wherein the transmission pattern comprises a retransmission pattern or a hybrid automatic repeat-request retransmission pattern. A program storage device as in any above, wherein the machine comprises a base station.

A program storage device as in any above, wherein the communication system comprises a packet communication system or a HSPA system. A program storage device as in any above, the operations further comprising: transmitting a communication to the plurality of users via the downlink shared channel. A program storage device as in any above, the operations further comprising: transmitting a communication to the plurality of users via the downlink shared channel, wherein the communication comprises a multimedia broadcast/multicast service transmission. A program storage device as in any above, wherein the downlink shared channel comprises a high speed downlink shared channel or a physical downlink shared channel. A program storage device as in any above, wherein the communication system comprises a wireless communication system.

(4) In another exemplary embodiment, an apparatus comprising: a receiver configured to obtain feedback from at least one mobile terminal in a communication system; and a processor configured to determine, based on the obtained feedback, whether at least one of a downlink shared channel transmit power and a transmission pattern should be modified, wherein the downlink shared channel is used to communicate with a plurality of users, wherein the processor is further configured to modify at least one of the downlink shared channel transmit power and the transmission pattern in response to determining that at least one of the downlink shared channel transmit power and the transmission power should be modified.

An apparatus as above, wherein the obtained feedback comprises a negative acknowledgement, channel quality information or a channel quality information report. An apparatus as in any above, wherein the processor determining whether the downlink shared channel transmit power should be modified comprises the processor using at least the obtained feedback, a number of mobile terminals in the communication system and a predetermined value. An apparatus as in any above, wherein the obtained feedback comprises a negative acknowledgement, wherein the processor determining whether the downlink shared channel transmit power should be modified comprises the processor comparing a number of obtained negative acknowledgements to a number of mobile terminals in the communication system and the processor increasing or decreasing the downlink shared channel transmit power in response to the comparison exceeding, equaling or falling below a predetermined value. An apparatus as in any above, wherein the obtained feedback comprises a channel quality information (CQI) report, wherein the processor determining whether the downlink shared channel transmit power should be modified comprises the processor approximating an amount of CQI reports that are below a modulation and coding scheme and the processor comparing the approximated amount to a predefined value.

An apparatus as in any above, wherein the obtained feedback comprises channel quality information (CQI), wherein the processor determining whether the transmission pattern should be modified comprises the processor using a lowest CQI to calculate an inter-transmission time interval (TTI) distance to provide constant bit rate service, wherein the transmission pattern is modified by the processor based on the calculated inter-TTI distance. An apparatus as in any above, wherein the transmission pattern comprises a retransmission pattern or a hybrid automatic repeat-request retransmission pattern. An apparatus as in any above, further comprising: a transmitter configured to transmit a communication to the plurality of users via the downlink shared channel, wherein the communication comprises a multimedia broadcast/multicast service transmission and the downlink shared channel comprises a high speed downlink shared channel or a physical downlink shared channel. An apparatus as in any above, wherein the apparatus comprises a base station.

An apparatus as in any above, wherein the communication system comprises a packet communication system or a HSPA system. An apparatus as in any above, further comprising: a transmitter configured to transmit a communication to the plurality of users via the downlink shared channel. An apparatus as in any above, further comprising: a transmitter configured to transmit a communication to the plurality of users via the downlink shared channel, wherein the communication comprises a multimedia broadcast/multicast service transmission. An apparatus as in any above, wherein the downlink shared channel comprises a high speed downlink shared channel or a physical downlink shared channel. An apparatus as in any above, wherein the communication system comprises a wireless communication system.

(5) In another exemplary embodiment, an apparatus comprising: means for obtaining feedback from at least one mobile terminal in a communication system; means for determining, based on the obtained feedback, whether at least one of a downlink shared channel transmit power and a transmission pattern should be modified, wherein the downlink shared channel is used to communicate with a plurality of users; and means for modifying at least one of the downlink shared channel transmit power and the transmission pattern in response to determining that at least one of the downlink shared channel transmit power and the transmission pattern should be modified.

An apparatus as above, wherein the means for obtaining comprises a receiver and the means for determining and means for modifying comprise a processor. An apparatus as in any above, wherein the obtained feedback comprises a negative acknowledgement, channel quality information or a channel quality information report. An apparatus as in any above, wherein the means for determining uses at least the obtained feedback, a number of mobile terminals in the communication system and a predetermined value. An apparatus as in any above, wherein the obtained feedback comprises a negative acknowledgement, wherein the means for determining comprises means for comparing a number of obtained negative acknowledgements to a number of mobile terminals in the communication system and means for increasing or decreasing the downlink shared channel transmit power in response to the comparison exceeding, equaling or falling below a predetermined value. An apparatus as in any above, wherein the obtained feedback comprises a channel quality information (CQI) report, wherein the means for determining comprises means for approximating an amount of CQI reports that are below a modulation and coding scheme and means for comparing the approximated amount to a predefined value.

An apparatus as in any above, wherein the obtained feedback comprises channel quality information (CQI), wherein the means for determining comprises means for using a lowest CQI to calculate an inter-transmission time interval (TTI) distance to provide constant bit rate service, wherein the transmission pattern is modified by based on the calculated inter-TTI distance. An apparatus as in any above, wherein the transmission pattern comprises a retransmission pattern or a hybrid automatic repeat-request retransmission pattern. An apparatus as in any above, further comprising: means for transmitting a communication to the plurality of users via the downlink shared channel, wherein the communication comprises a multimedia broadcast/multicast service transmission and the downlink shared channel comprises a high speed downlink shared channel or a physical downlink shared channel. An apparatus as in any above, wherein the apparatus comprises a base station.

An apparatus as in any above, wherein the communication system comprises a packet communication system or a HSPA system. An apparatus as in any above, further comprising: means for transmitting a communication to the plurality of users via the downlink shared channel. An apparatus as in any above, further comprising: means for transmitting a communication to the plurality of users via the downlink shared channel, wherein the communication comprises a multimedia broadcast/multicast service transmission. An apparatus as in any above, wherein the downlink shared channel comprises a high speed downlink shared channel or a physical downlink shared channel. An apparatus as in any above, wherein the communication system comprises a wireless communication system.

The exemplary embodiments of the invention, as discussed above and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

The exemplary embodiments of the invention, as discussed above and as particularly described with respect to exemplary methods, may be implemented in conjunction with a program storage device readable by a machine, tangibly embodying a program of instructions executable by the machine for performing operations. The operations comprise steps of utilizing the exemplary embodiments or steps of the method.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

While the exemplary embodiments have been described above in the context of a 3G HSPA system utilizing HSDPA, it should be appreciated that the exemplary embodiments of this invention are not limited for use with only this one particular type of wireless communication system, and that they may be used to advantage in other packet-based communication systems.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The exemplary embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of the non-limiting and exemplary embodiments of this invention.

Furthermore, some of the features of the preferred embodiments of this invention could be used to advantage without the corresponding use of other features. As such, the foregoing description should be considered as merely illustrative of the principles, teachings and exemplary embodiments of this invention, and not in limitation thereof.

What is claimed is:

1. A method comprising:
obtaining feedback from at least one mobile terminal in a communication system;
determining, based on the obtained feedback, whether at least one of a downlink shared channel transmit power and a transmission pattern should be modified, wherein the downlink shared channel is used to communicate with a plurality of users; and
in response to determining that at least one of the downlink shared channel transmit power and the transmission pattern should be modified, modifying at least one of the downlink shared channel transmit power and the transmission pattern.

2. A method as in claim 1, wherein the obtained feedback comprises a negative acknowledgement, channel quality information or a channel quality information report.

3. A method as in claim 1, wherein determining whether the downlink shared channel transmit power should be modified comprises using at least the obtained feedback, a number of mobile terminals in the communication system and a predetermined value.

4. A method as in claim 1, wherein the obtained feedback comprises a negative acknowledgement, wherein determining whether the downlink shared channel transmit power should be modified comprises comparing a number of obtained negative acknowledgements to a number of mobile terminals in the communication system and increasing or decreasing the downlink shared channel transmit power in response to the comparison exceeding, equaling or falling below a predetermined value.

5. A method as in claim 1, wherein the obtained feedback comprises a channel quality information (CQI) report, wherein determining whether the downlink shared channel transmit power should be modified comprises approximating an amount of CQI reports that are below a modulation and coding scheme and comparing the approximated amount to a predefined value.

6. A method as in claim 1, wherein the obtained feedback comprises channel quality information (CQI), wherein determining whether the transmission pattern should be modified comprises using a lowest CQI to calculate an inter-transmission time interval (TTI) distance to provide constant bit rate service, wherein the transmission pattern is modified based on the calculated inter-TTI distance.

7. A method as in claim 1, wherein the transmission pattern comprises a retransmission pattern or a hybrid automatic repeat-request retransmission pattern.

8. A method as in claim 1, further comprising: transmitting a communication to the plurality of users via the downlink shared channel, wherein the communication comprises a multimedia broadcast/multicast service transmission and the downlink shared channel comprises a high speed downlink shared channel or a physical downlink shared channel.

9. A program storage device readable by a machine, tangibly embodying a program of instructions executable by the machine for performing operations, said operations comprising:
obtaining feedback from at least one mobile terminal in a communication system;
determining, based on the obtained feedback, whether at least one of a downlink shared channel transmit power and a transmission pattern should be modified, wherein the downlink shared channel is used to communicate with a plurality of users; and
in response to determining that at least one of the downlink shared channel transmit power and the transmission pattern should be modified, modifying at least one of the downlink shared channel transmit power and the transmission pattern.

10. A program storage device as in claim 9, wherein the obtained feedback comprises a negative acknowledgement, channel quality information or a channel quality information report.

11. A program storage device as in claim 9, wherein determining whether the downlink shared channel transmit power should be modified comprises using at least the obtained feedback, a number of mobile terminals in the communication system and a predetermined value.

12. A program storage device as in claim 9, wherein the obtained feedback comprises a negative acknowledgement, wherein determining whether the downlink shared channel transmit power should be modified comprises comparing a number of obtained negative acknowledgements to a number of mobile terminals in the communication system and increasing or decreasing the downlink shared channel transmit power in response to the comparison exceeding, equaling or falling below a predetermined value.

13. A program storage device as in claim 9, wherein the obtained feedback comprises a channel quality information (CQI) report, wherein determining whether the downlink shared channel transmit power should be modified comprises approximating an amount of CQI reports that are below a modulation and coding scheme and comparing the approximated amount to a redefined value.

14. A program storage device as in claim 9, wherein the obtained feedback comprises channel quality information (CQI), wherein determining whether the transmission pattern should be modified comprises using a lowest CQI to calculate an inter-transmission time interval (TTI) distance to provide constant bit rate service, wherein the transmission pattern is modified based on the calculated inter-TTI distance.

15. A program storage device as in claim 9, wherein the transmission pattern comprises a retransmission pattern or a hybrid automatic repeat-request retransmission pattern.

16. A program storage device as in claim 9, wherein the machine comprises a base station.

17. An apparatus comprising:
a receiver configured to obtain feedback from at least one mobile terminal in a communication system; and
a processor configured to determine, based on the obtained feedback, whether at least one of a downlink shared channel transmit power and a transmission pattern should be modified, wherein the downlink shared channel is used to communicate with a plurality of users,
wherein the processor is further configured to modify at least one of the downlink shared channel transmit power and the transmission pattern in response to determining that at least one of the downlink shared channel transmit power and the transmission power should be modified.

18. An apparatus as in claim 17, wherein the obtained feedback comprises a negative acknowledgement, channel quality information or a channel quality information report.

19. An apparatus as in claim 17, wherein the processor determining whether the downlink shared channel transmit power should be modified comprises the processor using at least the obtained feedback, a number of mobile terminals in the communication system and a predetermined value.

20. An apparatus as in claim 17, wherein the obtained feedback comprises a negative acknowledgement, wherein the processor determining whether the downlink shared channel transmit power should be modified comprises the processor comparing a number of obtained negative acknowledgements to a number of mobile terminals in the communication system and the processor increasing or decreasing the downlink shared channel transmit power in response to the comparison exceeding, equaling or falling below a predetermined value.

21. An apparatus as in claim 17, wherein the obtained feedback comprises a channel quality information (CQI) report, wherein the processor determining whether the downlink shared channel transmit power should be modified comprises the processor approximating an amount of CQI reports that are below a modulation and coding scheme and the processor comparing the approximated amount to a predefined value.

22. An apparatus as in claim 17, wherein the obtained feedback comprises channel quality information (CQI), wherein the processor determining whether the transmission pattern should be modified comprises the processor using a lowest CQI to calculate an inter-transmission time interval (TTI) distance to provide constant bit rate service, wherein the transmission pattern is modified by the processor based on the calculated inter-TTI distance.

23. An apparatus as in claim 17, wherein the transmission pattern comprises a retransmission pattern or a hybrid automatic repeat-request retransmission pattern.

24. An apparatus as in claim 17, further comprising: a transmitter configured to transmit a communication to the plurality of users via the downlink shared channel, wherein the communication comprises a multimedia broadcast/multicast service transmission and the downlink shared channel comprises a high speed downlink shared channel or a physical downlink shared channel.

25. An apparatus as in claim 17, wherein the apparatus comprises a base station.

26. An apparatus comprising:
means for obtaining feedback from at least one mobile terminal in a communication system;
means for determining, based on the obtained feedback, whether at least one of a downlink shared channel transmit power and a transmission pattern should be modified, wherein the downlink shared channel is used to communicate with a plurality of users; and
means for modifying at least one of the downlink shared channel transmit power and the transmission pattern in response to determining that at least one of the downlink shared channel transmit power and the transmission pattern should be modified.

27. An apparatus as in claim 26, wherein the means for obtaining comprises a receiver and the means for determining and means for modifying comprise a processor.

28. An apparatus as in claim 26, wherein the obtained feedback comprises a negative acknowledgement, channel quality information or a channel quality information report.

29. An apparatus as in claim 26, wherein the means for determining uses at least the obtained feedback, a number of mobile terminals in the communication system and a predetermined value.

30. An apparatus as in claim 26, wherein the obtained feedback comprises a negative acknowledgement, wherein the means for determining comprises means for comparing a number of obtained negative acknowledgements to a number of mobile terminals in the communication system and means for increasing or decreasing the downlink shared channel transmit power in response to the comparison exceeding, equaling or falling below a predetermined value.

31. An apparatus as in claim 26, wherein the obtained feedback comprises a channel quality information (CQI) report, wherein the means for determining comprises means for approximating an amount of CQI reports that are below a modulation and coding scheme and means for comparing the approximated amount to a predefined value.

32. An apparatus as in claim 26, wherein the obtained feedback comprises channel quality information (CQI), wherein the means for determining comprises means for using a lowest CQI to calculate an inter-transmission time interval (TTI) distance to provide constant bit rate service, wherein the transmission pattern is modified by based on the calculated inter-TTI distance.

33. An apparatus as in claim 26, wherein the transmission pattern comprises a retransmission pattern or a hybrid automatic repeat-request retransmission pattern.

34. An apparatus as in claim 26, further comprising: means for transmitting a communication to the plurality of users via the downlink shared channel, wherein the communication comprises a multimedia broadcast/multicast service transmission and the downlink shared channel comprises a high speed downlink shared channel or a physical downlink shared channel.

35. An apparatus as in claim 26, wherein the apparatus comprises a base station.
